(19) United States
(12) Patent Application Publication
(10) Pub. No.: US 2003/0090557 A1
(43) Pub. Date: May 15, 2003

(54) Combination printer

(76) Inventor: Johannes Lenkl, Freising (DE)

Correspondence Address: CHRISTIE, PARKER & HALE, LLP, 350 WEST COLORADO BOULEVARD, SUITE 500, PASADENA, CA, 91105, US

(21) Appl. No.: 10/312,169

(22) PCT Filed: Mar. 20, 2002
(86) PCT No.: PCT/EP02/03125

(30) Foreign Application Priority Data
Mar. 20, 2001 (DE) 101 13 558.0

(51) Int. Cl. B41J 2/01

(52) U.S. Cl. 347/104

(57) ABSTRACT

The invention relates to a printer for printing print media arranged on a support track (E), in particular, labels and similar, comprising at least one thermo-transfer printer unit (70). Furthermore at least one ink-jet printer unit (30) is provided up-stream of the thermo-transfer printer unit (70).

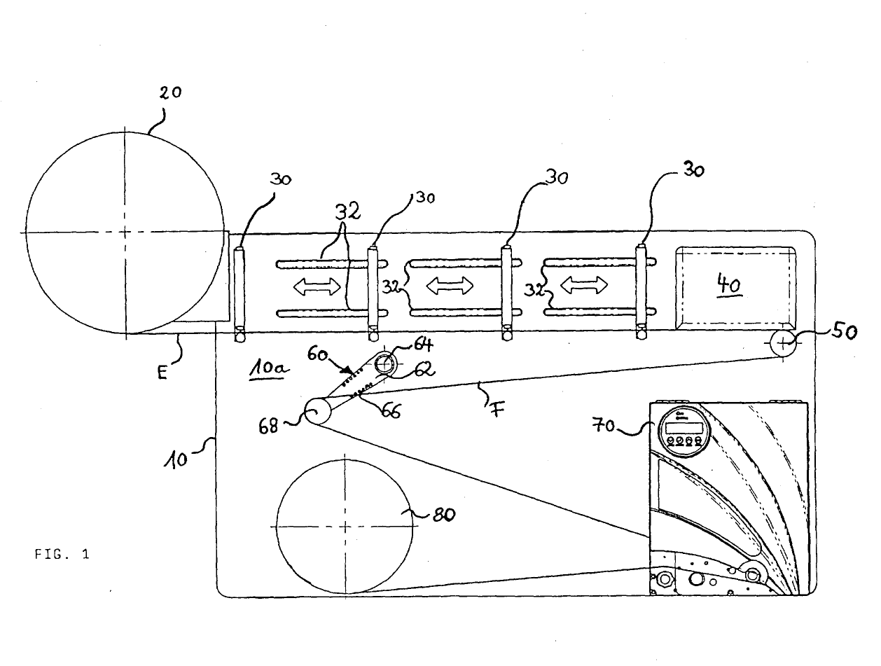

The invention concerns a printer for printing on print media arranged on a support web, in particular labels and the like, which has at least one thermal transfer printer unit.

Printers of that kind are used inter alia for printing labels with items of product information as for example in the case of articles of clothing, the size, the price and so forth. The thermal transfer printers which are used for that purpose normally operate only with a single thermal transfer film or foil so that labels of that kind can only be printed upon with one color. In order therefore to use colored labels it is necessary for those labels, in a preceding step, to be provided with color printing thereon, in which case one or more data fields remain free for printing thereon by means of the thermal transfer printer. Those labels are then fed to the thermal transfer printer for printing the respectively desired data thereon.

An operating procedure of that kind is found to be disadvantageous from several points of view. Thus firstly the colored printing on the labels, which is separated in respect of space and time from the thermal transfer printing operation, means that both transport runs and also storage space are necessary. Furthermore a flexible configuration which relates to current situations can only be achieved with difficulty.

Admittedly, thermal transfer printers are also known in a practical context, which use a plurality of thermal transfer films of different colors. However printers of that kind are disproportionately expensive in regard to consumable material in the form of the transfer films, as on the one hand the film itself is very costly but on the other hand the consumption of thermal transfer film is also high.

Finally, multi-color ink jet printers are also known in practice. Printers of that kind however are not suitable for printing on print media which, shortly before the issue thereof, also have to be provided with topical current data as is the case for example with labels. Because of the long drying time of the ink printers of that kind can only issue a print medium with a long time delay. Alternatively suitable drying means have to be provided for printers of that kind.

Therefore the object of the present invention is to provide a printer of the kind set forth in the opening part of this specification, which makes it possible to produce colored print media in conjunction with a thermal transfer printing process.

The foregoing object is attained by the features of claim 1. Advantageous configurations in that respect are set forth in subsequent claims 2 through 19.

The fact that the ink jet printer unit can deal with a different color from the thermal transfer printer unit readily affords the possibility of providing a print medium such as for example a label with an at least two-color printing thereon. As the ink jet printer unit is arranged upstream of the thermal transfer printer unit there is further the possibility that the ink applied to the single print medium can be dried prior to being fed to the thermal transfer printer unit. In addition arranging the ink jet printer unit upstream of the thermal transfer printer unit in the direction of conveying movement of the print media support web can provide for drying of the ink applied to the print medium. That affords the possibility of using print media which, shortly before the issue thereof, also have to be printed upon with topical and current data as that can be effected by the thermal transfer printer unit.

The time for finishing an image produced with an ink jet printer unit, by virtue of the requirement for drying of the applied ink, is markedly longer in comparison with the image-finishing time involved with a thermal transfer printer unit. In order to ensure an independent mode of operation both of the ink jet printer unit and also the thermal transfer printer unit when employing a print media support web which is passed continuously through the printer, it is further advantageous if, between the two printer units, there is provided a buffer unit for compensating for the different processing times or forward feed speeds of the thermal transfer printer unit and the ink jet printer unit.

Different structures can be provided for the buffer unit. Thus there is firstly for example the possibility of the buffer unit being formed by a dancer arm which bears against the print media support web. That arrangement makes it possible to form between the ink jet printer unit and the thermal transfer printer unit a support web loop, the length of which can vary as a result of the pivotability of the dancer arm and can thus compensate for the differing forward feed speed or processing times as between the ink jet printer unit and the thermal transfer printer unit, in spite of the support web being continuously present. If for example no label is to be issued or printed upon by the thermal transfer printer unit, then the slower ink jet printer unit can already print on one or more print media as a supply thereof, in which case the support web, by virtue of the dancer arm, can provide for a compensating effect as between the two printer units. That can be effected by the dancer arm, particularly in the feed direction of the support web to the dancer arm, being elastically biased into an initial position for example by a spring means. That arrangement can provide for accommodating the support web conveyed by a conveyor device, although the thermal transfer printer unit is not issuing any label and thus also the portion of the support web, which is present between the dancer arm and the thermal transfer printer unit, is also not being conveyed.

In order to achieve low-friction guidance of the print media support web at the dancer arm, it is further advantageous if the dancer arm is provided at its free end with a roller for low-friction guidance of the print media support web.

Equally the buffer unit can be formed by at least two conveyor rollers arranged at the transportation path of the print media support web in mutually spaced relationship and by at least one sensor for detecting the position of the print media support web arranged between the two conveyor rollers. The two conveyor rollers which are drivable independently of each other, depending on the respectively detected position of the support web by the sensor, can then implement a feed of further support web into the region between the two conveyor rollers, in such a way that the first conveyor roller in the direction of conveying movement of the support web is driven, whereas the second conveyor roller which is downstream of the first conveyor roller in the direction of conveying movement remains stopped or stationary. In order to draw off the support web in the region between the two conveyor rollers, the second conveyor roller can then be set in operation whereas the first conveyor roller remains stopped. It will be appreciated that it is also possible for both conveyor rollers to be driven at the same time.

In order to be able to process print media of different sizes and lengths, using one and the same printer, it is advantageous if the ink jet printer unit is adjustable in position in a direction parallel to the print media support web.

The adjustability of the ink jet printer unit in parallel relationship with the print media support web makes it possible to adjust the position of the ink jet printer unit precisely relative to the print media support web, as is required for a clean print. That can be effected for example by the ink jet printer unit being held to a vertical wall of a housing of the printer, which has at least one and preferably two horizontal slots which extend in mutually parallel relationship and along which the ink jet printer unit is mounted slidably.

In order to produce a multi-color ink jet printing effect, it has further proven to be advantageous if there are provided a plurality of and in particular four ink jet printer units, preferably for inks of different colors, which are arranged in succession and at mutually spaced relationship along the path of transportation movement of the print media support web. In this case each of the ink jet printer units can accommodate or process one of the following colors, yellow, blue, green or red.

In that respect it is advantageous if the ink jet printer units are at an equal spacing from each other, which preferably substantially corresponds to the spacing of the print media on the print media support web. Equally it is possible for the spacing between the ink jet printer units to correspond to just one of the length or a multiple of the length of a print medium on the print media support web. That is advantageous in particular when the print media are of a comparatively short length and the print heads of the ink jet printer units are comparatively thick or long. In such a situation it would not be possible to implement positioning of a print medium between two printer units during the phase when the printer according to the invention is out of operation. Therefore, with such a design configuration a plurality of print media can be arranged between two ink jet printer units.

In order to avoid running of the colored ink applied by the ink jet printer unit on the print media it is further advantageous if the path of conveying movement of the print media support web extends horizontally under the ink jet printer unit. It will be appreciated that it is also possible to envisage a different orientation of the print media support web, in particular if it is ensured that the ink used can run after being applied to the print medium.

In order to feed the unprinted print media support web, in a space-saving fashion, it is further advantageous if it is wound on to a dispensing reel which is arranged upstream of the ink jet printer unit.

In order to achieve ink drying which is as fast as possible, it is further advantageous if a drying unit is arranged adjoining the ink jet printer unit downstream thereof. In that case the drying unit may be a UV-drying unit.

In order to achieve easy dispensing of the individual printed print media, it is further provided that arranged downstream of the transfer printer unit is a dispensing unit for dispensing individual print media detached from the print media support web by the dispensing unit. So that the empty support web can be accommodated in a space-saving fashion, it is further advantageous if a winding-up reel for the empty print media support web is arranged downstream of the dispensing unit.

A particularly desirable and space-saving configuration for the path of conveying movement of the print media support web can be achieved if the path of conveying movement of the support web extends substantially in a z-shape from the ink jet printer unit to the thermal transfer printer unit.

In principle the print media conveyor web can be transported with conveyor devices specifically provided for same, through the printer, along the path of conveying movement. A particularly space-saving structure can be achieved if the ink jet printer unit and/or the thermal transfer printer unit are respectively provided with at least one conveyor device.

Further advantageous configurations and an embodiment by way of example are described hereinafter with reference to the accompanying FIGURE. In this connection it is to be noted that the terms ‘left’, ‘right’, ‘bottom’ and ‘top’ used in this description refer to the FIGURE with the references in a normally readable orientation.

The single FIGURE diagrammatically reproduces a printer according to the invention. The printer according to the invention serves for printing on print media in the form of labels. The labels are arranged on a print media or label support web E at equal spacings relative to each other in the direction of conveying movement of the support web E. The labels support web E is drawn off a dispensing reel 20 which is arranged outside a housing 10 of the printer in the top left region of the printer 10 and which is arranged rotatably and interchangeably on a horizontal spindle (not shown). From the dispensing reel 20 the labels support web E is guided into the interior of the housing 10 on a path F of conveying movement, which extends substantially horizontally in that region, for the labels web E, firstly to a total of four ink jet printer units 30.

The four ink jet printer units 30, each of which applies a different color to the labels, are arranged at equal spacings relative to each other at a vertical wall 10a of the printer housing 10. That spacing is determined by the spacing of the labels on the labels support web E. The spacing in this case is to be such that, when a printer is stopped, a respective label is disposed between two successive ink jet printer units so that, outside a printing operation, the intermediate spaces between two successive labels are arranged precisely below each ink jet printer unit 30.

In order to be able to adjust the position of the ink jet printer units 30 and thus the spacing between them, provided in the vertical wall 100 for each of the ink jet printer units 30 disposed upstream after the first ink jet printer unit 30 are two respective horizontal slots 32 which extend in mutually parallel relationship and along which the respective ink jet printer unit 30 can be reversibly displaced along the path F of conveying movement of the labels support web E and fixed again.

Provided downstream of the four ink jet printer units 30 is a drying unit 40 which in the present case is formed by a UV drying unit. Provided at the right beneath the drying unit 40 is a conveyor roller 50 which serves to drive the labels support web E. That support web E is deflected through about 180° at the conveyor roller 50 and passes into a buffer region which includes a buffer unit 60. The buffer unit 60 is formed by a dancer arm 62 which is mounted rotatably about a shaft 64 supported in a horizontal orientation on the housing 10. The dancer arm 62 is biased by a biasing spring 66 in the feed direction of the labels support web E to the buffer unit 60, that is to say in a direction towards the left. At its free end the dancer arm 62 has a roller 68 in order to deflect the labels support web E through an angle of about 135° in a direction towards a thermal transfer printer unit 70. The path of conveying movement F for the labels support web E, from the dispensing reel 20 to the thermal transfer printer unit 70, forms a substantially Z-shaped path.

In the thermal transfer printer unit 70 the labels which are printed in color by the ink jet printer units 30 are provided with thermal transfer printing, for which the thermal transfer printer unit 70 has a thermal transfer film (not shown). In addition the thermal transfer printer unit 70 also has a dispensing unit (not shown) which is capable of detaching an individual label from the labels support web E and issuing it from the printer by way of a dispensing edge. The labels support web E from which the labels have been removed is passed from the thermal transfer printer unit 70 to a winding-up reel 80 which is interchangeably supported at a horizontal shaft (not shown) within the housing 10 of the printer.

For colored printing of the labels firstly a full, unprinted dispensing reel 20 for the labels support web E is mounted on the printer. Then a suitable length of web is drawn off the dispensing reel 20 so that the Z-shaped path F of conveying movement, within the printer, is occupied completely as far as the dispensing edge of the dispensing unit of the thermal transfer printer unit 70 with the labels support web E. The three ink jet printer units 30 which follow the first ink jet printer unit 30 upstream thereof are then possibly so adjusted in their position that a respective label is disposed between each two successive ink jet printer units 30. Thereupon the first labels, that is to say that label which is on the labels support web E upstream of the ink jet printer unit 30 which is first in the direction of conveying movement of the labels support web E, can be pulled under that printer unit 30 and printed. After the printing operation in the first ink jet printer unit 30 the label is further conveyed to the subsequent ink jet printer unit 30 and also printed there. That likewise applies for the other two ink jet printer units 30. While the first label to be printed is passing through the four ink jet printer units 30, further labels follow, which are then also successively printed by the four ink jet printer units 30.

After having passed through the drying unit 40 the labels support web E provided with printed labels is further conveyed by the conveyor roller 50 into the buffer region. As a consequence of biasing of the dancer arm 62 towards the left, the labels support web E which is conveyed in that way can be conveyed uniformly by the conveyor roller 50 into the buffer region. A sensor (not shown) can detect the deflection travel of the dancer arm 62 and the conveyor roller 50 can possibly be stopped thereby as soon as the buffer region is ‘filled’.

If now a label printed by the ink jet printer units 30 is provided with thermal transfer printing by the thermal transfer printer unit 70 and dispensed by means of the dispensing unit, the conveyor device (not shown) of the thermal transfer printer unit 70 conveys the labels support web E in the direction of the thermal transfer printer unit 70. By virtue thereof the dancer arm 62 is pulled towards the right so that the buffer region again has room for receiving further labels which have been printed by the ink jet printer units 30. Immediately after the issue of a label by the dispensing unit of the thermal transfer printer unit 70, further labels can then be printed by the ink jet printer units 30, or it is possible to wait until the dancer arm 62 assumes a predetermined position, that is to say a position to the right of the position shown in the single FIGURE, which identifies the fact that the buffer region has ‘run empty’. That can again be detected by the above-mentioned sensor or an additional sensor.

1. A printer for printing print media, in particular labels and the like, arranged on a support web (E), comprising at least one thermal transfer printer unit (70), characterised in that there is provided at least one ink jet printer unit (30) upstream of the thermal transfer printer unit (70).

2. A printer as set forth in claim 1 characterised in that provided between the ink jet printer unit (30) and the thermal transfer printer unit (70) is a buffer unit (60) for compensating for the different forward feed speeds of the thermal transfer printer unit (70) and the ink jet printer unit (30).

3. A printer as set forth in claim 2 characterised in that the buffer unit (60) is formed by a dancer arm (62) bearing against the print media support web (E).

4. A printer as set forth in claim 3 characterised in that the dancer arm (62) is biased into a starting position by means of an elastic biasing element (66).

5. A printer as set forth in claim 3 or claim 4 characterised in that the dancer arm (62) is provided at its free end with a roller (68) for low-friction guidance of the print media support web (E).

6. A printer as set forth in claim 2 characterised in that the buffer unit is formed by at least two conveyor rollers arranged in mutually spaced relationship at the path of transportation movement of the print media support web (E) and at least one sensor for detecting the position of the print media support web (E) which is arranged between the two conveyor rollers.

7. A printer as set forth in one of claims 1 through 6 characterised in that the position of the ink jet printer units (30) is adjustable in a direction parallel to the print media support web (E).

8. A printer as set forth in claim 7 characterised in that the ink jet printer unit (30) is held to a vertical wall (10a) which has at least one and preferably two horizontal slots (32) which extend in mutually parallel relationship and along which the ink jet printer unit (30) is slidably supported.

9. A printer as set forth in one of claims 1 through 8 characterised in that there are provided a plurality of and in particular four ink jet printer units (30), preferably for inks of different colors, which are arranged in succession and at mutually spaced relationship along the path (F) of conveying movement of the print media support web (E).

10. A printer as set forth in claim 9 characterised in that the spacing between the individual ink jet printer units (30) is identical.

11. A printer as set forth in claim 9 or claim 10 characterised in that the spacing between the ink jet printer units (30) corresponds to just the length or a multiple of the length of a print medium on the print media support web (E).

12. A printer as set forth in one of claims 1 through 11 characterised in that the path (F) of conveying movement of the print media support web (E) extends horizontally under the ink jet printer unit (30).

13. A printer as set forth in one of claims 1 through 12 characterised in that the unprinted print media support web (E) is wound on to a dispensing reel (20) which is arranged upstream of the ink jet printer unit (30).

14. A printer as set forth in one of claims 1 through 13 characterised in that a drying unit (40) adjoins the ink jet printer unit (30) downstream thereof.

15. A printer as set forth in claim 14 characterised in that the drying unit is a UV drying unit (40).

16. A printer as set forth in one of claims 1 through 14 characterised in that arranged downstream of the thermal transfer printer unit (70) is a dispensing unit for dispensing individual print media detached from the print media support web (F) by the dispensing unit.

17. A printer as set forth in claim 16 characterised in that arranged downstream of the dispensing unit is a winding-up reel (80) for the empty print media support web (E).

18. A printer as set forth in one of claims 1 through 17 characterised in that the path (F) of conveying movement of the print media support web (E) extends in a Z-shape from the ink jet printer unit (30) to the thermal transfer printer unit (70).

19. A printer as set forth in one of claims 1 through 18 characterised in that the ink jet printer unit (30) and/or the thermal transfer printer unit (70) is provided with at least one conveyor device for transporting the print media conveyor web (E).
